(19) United States
(12) Patent Application Publication
(10) Pub. No.: US 2011/0080300 A1
(43) Pub. Date: Apr. 7, 2011

(54) MONITORING DEVICE FOR ELECTRONIC DEVICES

(76) Inventors: Ben BEQUETTE, Caseyville, IL (US); Aaron BAUZA, Belleville, IL (US)

(21) Appl. No.: 12/900,264

(22) Filed: Oct. 7, 2010

Related U.S. Application Data
(60) Provisional application No. 61/278,492, filed on Oct. 7, 2009.

(51) Int. Cl. G08B 21/00

(52) U.S. Cl. 340/686.6

(57) ABSTRACT

A monitoring device for use in a vehicle includes a body configured to be mounted within the vehicle. A controller is housed within the body that has a communication module configured to detect the presence and/or absence of at least one electronic device in the vicinity of the monitoring device by attempting wireless communication with at least one electronic device. An indicator is held by the body and is operatively connected to the controller for controlling the operation of the indicator. The controller is operated in a first mode when the communication module detects the presence of the at least one electronic device and is operated in a second mode when the communication module does not detect the presence of the at least one electronic device.

### CROSS REFERENCE TO RELATED APPLICATION

The present application is related to and claims priority from provisional application having U.S. Application Ser. No. 61/278,492 filed Oct. 7, 2009, titled “MONITORING DEVICE FOR ELECTRONIC DEVICES”, the complete subject matter of which is hereby expressly incorporated by reference in its entirety.

### BACKGROUND OF THE INVENTION

The subject matter herein relates generally to monitoring devices and more specifically it relates to monitoring devices to detect the presence and/or absence of other electronic devices in the vicinity of the monitoring device.

Wireless communication devices are known to communicate with other electronic devices, such as cell phones. These wireless communication devices have many uses. One particular application is use in vehicles such as cars. The wireless communication devices use certain protocols, such as Bluetooth technology, to communicate with the electronic devices. Typical examples of use of such wireless communication is to sync a particular cell phone with a hands-free phone system embedded within the vehicle. Upon entry into the vehicle; the cell phone is automatically paired with the hands free phone system. Heretofore, such systems only operate when the cell phone is present. Such systems do not provide the user with an indication of the cell phone absence.

Another known problem, particularly with cell phones or other electronic devices, is that such devices may be left or put in an unwanted area. For example, the cell phone or electronic device may be left in a pocket of an article of clothing, which is then put in the washing machine.

A need remains for a system that can be used to detect the presence and/or absence of a cell phone in a particular area. A need remains for a system that will notify the user(s) that their cell phone(s) is not present upon entering the vehicle. A need remains for a system that will notify the user(s) that their cell phone(s) are present in an undesired location, such as in a washing machine.

### BRIEF DESCRIPTION OF THE INVENTION

The subject matter herein generally relates to monitoring devices which includes software and/or hardware capable of detecting the presence and/or absence of an electronic device, such as a cell phone, upon a predetermined event or condition. The monitoring device is capable of detecting the presence and/or absence of the cell phone within a particular area, such as within the confines of a vehicle, a particular room, an appliance and the like.

In one embodiment, a monitoring device is provided for use in a vehicle. The monitoring device includes a body configured to be mounted within the vehicle. A controller is housed within the body that has a communication module configured to detect the presence and/or absence of at least one electronic device in the vicinity of the monitoring device by attempting wireless communication with at least one electronic device. An indicator is held by the body and is operatively connected to the controller for controlling the operation of the indicator. The controller is operated in a first mode when the communication module detects the presence of the at least one electronic device and is operated in a second mode when the communication module does not detect the presence of the at least one electronic device.

In another embodiment, a monitoring device is provided for use in a vehicle. The monitoring device has a wireless communication component contained within the vehicle. The wireless communication component is configured to pair with a first cell phone in the compartment of the vehicle, wherein, upon a predetermined event, the wireless communication component is operated to verify the presence and/or absence of the first cell phone.

In a further embodiment, a monitoring device is provided for use with an appliance. The monitoring device has a body configured to be mounted adjacent the appliance. A controller is housed within the body that has a communication module configured to detect the presence and/or absence of at least one electronic device in the vicinity of the monitoring device by attempting wireless communication with the electronic device. An indicator is held by the body and is operatively connected to the controller for controlling the operation of the indicator. The controller is operated in a first mode when the communication module detects the presence of the at least one electronic device, and the controller is operated in a second mode when the communication module does not detect the presence of the at least one electronic device.

### BRIEF DESCRIPTION OF THE DRAWINGS

FIG. 1 is a schematic illustration of a monitoring device formed in accordance with an exemplary embodiment.

FIG. 2 is a schematic illustration of the monitoring device shown in FIG. 1 in use within a vehicle.

FIG. 3 is a front view of the monitoring device shown in FIG. 1.

FIG. 4 is a side view of the monitoring device shown in FIG. 1.

FIG. 5 is a flow chart illustrating an exemplary operation of the monitoring device shown in FIG. 1.

FIG. 6 is a schematic illustration of an alternative monitoring device for use in a different application.

FIG. 7 illustrates an alternative electronic device that may be monitored by the monitoring device.

### DETAILED DESCRIPTION OF THE INVENTION

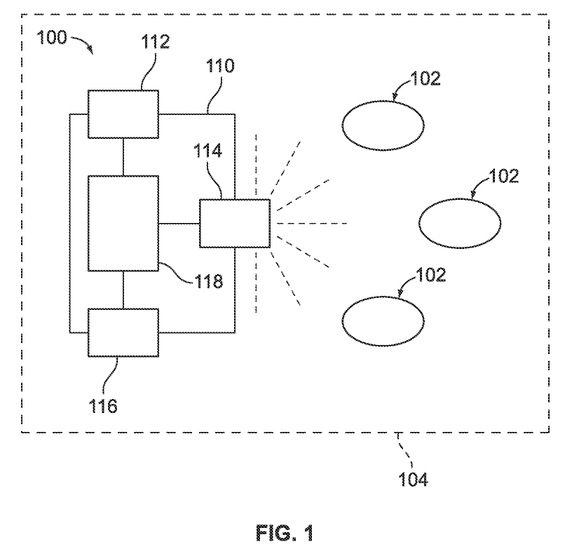

FIG. 1 illustrates a monitoring device 100 formed in accordance with an exemplary embodiment that is used to detect the presence and/or absence of one or more electronic devices 102 in the vicinity of the monitoring device 100. The monitoring device 100 is capable of communicating wirelessly with the electronic device 102. The monitoring device 100 includes software and/or hardware that is capable of detecting the presence and/or absence of the electronic device 102. Upon a predetermined event or condition, the monitoring device 100 interrogates an interrogation volume or space 104 to search for the electronic devices 102. In an exemplary embodiment, the monitoring device 100 is paired with certain electronic devices 102 and the monitoring device 100 interrogates the space 104 for only the paired electronic devices 102. Alternatively, the monitoring device 100 may be configured to interrogate the space 104 for any electronic device 102 of a particular type, and such electronic devices 102 do not need to be previously paired with the monitoring device 100 for the monitoring device 100 to detect the presence of such electronic devices 102.

In an exemplary embodiment, the monitoring device 100 is particularly adapted for use in detecting the presence and/or absence of cell phones within a particular area, such as within the confines of a vehicle, within a particular room, or within any electronic component such as an appliance (e.g., a washing machine). In one particular application, the monitoring device 100 is used to detect the presence and/or absence of one or more cell phones within a vehicle. The monitoring device 100 is useful for indicating to the passenger or passengers within the vehicle whether or not a particular cell phone is within the vehicle. In another application, the monitoring device 100 may be used within a particular room, such as a laundry room, for detecting the presence of a cell phone in the vicinity of an appliance, such as a washing machine. The monitoring device 100 may indicate to the user that a cell phone is in the vicinity of the washing machine. For example, if the user accidentally leaves their cell phone in their pocket, the monitoring device 100 may indicate to the user that the cell phone is in the washing machine so that the user does not start the washing machine.

The monitoring device 100 includes a controller 110 that controls the operation and functionality of the monitoring device 100. A power module 112 may be connected to the controller 110. The power module 112 may include a plug or other component that may be connected to a power source for supplying power to the monitoring device 100. The plug may be a standard 12 v plug that is received into a 12 v cigarette lighter or power port of the vehicle. Alternatively, the plug may be an AC power plug having male contact prongs that connect mechanically and electrically to slots in a matching wall socket or other electrical outlet. Alternatively, the power source may be hardwired into the power system of the vehicle or the appliance.

A communication module 114 is connected to the controller 110. The communication module 114 is configured to communicate wirelessly with the electronic devices 102. In an exemplary embodiment, the communication module 114 includes a Bluetooth component that is configured to operate in accordance with the Bluetooth wireless communication protocol. The communication module 114 may include a Bluetooth send/receive module incorporated therein. The communication module 114 may include other types of communication components in alternative embodiments. In an exemplary embodiment, the communication module 114 includes an antenna for transmitting and/or receiving signals between the monitoring device 100 and electronic device 102. The communication module 114 may be hardwired into the vehicle or appliance. For example, some vehicles come equipped with Bluetooth capability. The communication module 114 may be hardwired into such Bluetooth subsystem of the vehicle.

An indicator module 116 is connected to the controller 110. The indicator module 116 includes an indicator that indicates the presence and/or absence of the electronic device 102. The indicator module 116 may provide any type of indication to the user, such as visual indication, audible indication or other types of indications, such as by controlling another aspect of the vehicle or appliance that the monitoring device 100 is used with. In an exemplary embodiment, the indicator includes one or more LED bulbs that indicate a status of the monitoring device 100. The LED may be on, off, flash, or emit a particular color of light to indicate the status of the monitoring device 100. In an alternative embodiment, the indicator module 116 may include a speaker or other audible component that indicates the status of the monitoring device 100. For example, the speaker may beep or provide other audible indication of the presence and/or absence of the electronic device 102. In another alternative embodiment, the indicator module 116 may include a display, such as a digital display, that may indicate the status of the monitoring device 100. For example, the display may indicate which electronic devices 102 are present and/or which electronic devices 102 are absent. The display may indicate the number of electronic devices 102 present. In another alternative embodiment, the indicator module 116 may be communicatively coupled to another subsystem of the vehicle or the appliance, such as the radio system in the vehicle, the audio system of the vehicle, the control panel of the appliance and the like. The visual, audio or other indication may be broadcast through the other subsystem of the vehicle or the appliance.

A control module 118 is provided with the controller 110. The control module 118 includes a processor or computer that operates a control scheme to operate the monitoring device 100. The other modules may be connected to the control module 118 and controlled by the control module 118. The controller 110 and/or control module 118 may have tangible and non-transitory machine readable medium or media having instructions recorded thereon for the processor or computer to operate the monitoring device 100. The medium or media may be any type of computer readable medium. The computer processor may have a microprocessor and/or a graphics processing unit (GPU). The microprocessor may be connected to a communication bus. The computer processor may have a memory. The computer processor may further include a storage device, which may have means for loading programs or other instructions into the computer processor. The computer processor may use any type of processor based or microprocessor based system having integrated circuits, logic circuits, or other circuits or processors capable of executing the functions described herein. The computer processor executes to set of instructions that are stored in one or more storage elements in order to process input data. The storage elements may also store data or other information as desired or needed. The storage elements may be in the form of an information source or physical memory element with a processing machine. The set of instructions may include various command that instruct the computer processor as a processing machine to perform specific operations, such as the methods and processes of the various embodiments described herein. The set of instructions may be in the form of a software program. The software may be in various forms, such as system software or application software. The processing of input data by the processing machine may be in response to user commands, or in response to results of previous processing, or in response to requests made by another processing machine.

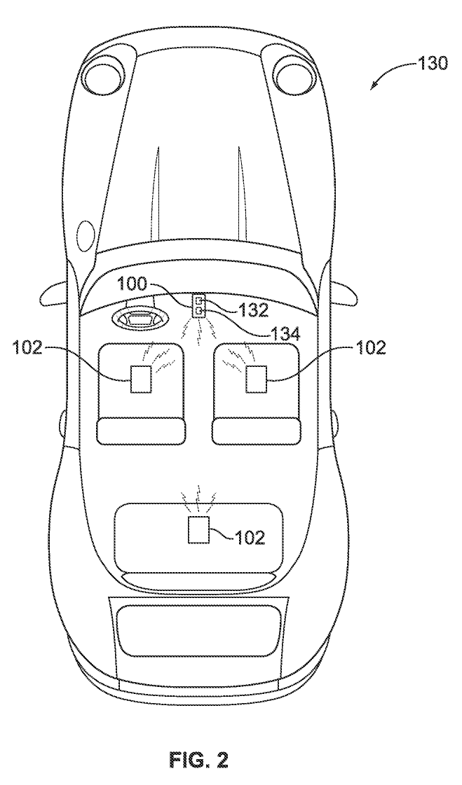

FIG. 2 is a schematic illustration of the monitoring device 100 in use within a vehicle 130. In an exemplary embodiment, the monitoring device 100 is removable from the vehicle 130. The monitoring device 100 may be plugged into a power port or a cigarette lighter of the vehicle 130 and receive power from the battery of vehicle 130. Upon a predetermined event or condition, such as placement of the key in the ignition, starting the car, unlocking the doors, a user sitting in the seat, activation of a sensor used to detect a users presence, turning on the monitoring device 100, and the like, the monitoring device 100 detects the presence and/or absence of electronic devices 102 within the vehicle 130.

In an exemplary embodiment, the monitoring device 100 includes a voltage monitoring module 132 connected to the controller 110 (shown in FIG. 1). The voltage monitoring module 132 senses a voltage of the vehicle 130 to monitor when the vehicle 130 is turned on. The voltage monitoring module 132 senses the engine starting by recognizing a voltage change. When the engine has started, it will trigger the monitoring device 100 to initiate an interrogation sequence.

In an exemplary embodiment, the electronic devices 102 are paired with the monitoring devices 100. When activated, the monitoring device 100 interrogates the compartment of the vehicle 130 and looks for only the electronic device 102 that have been previously paired with the monitoring device 100. The monitoring device 100 may include a pairing module 134 that may be connected to the controller 110. The monitoring device 100 may enter a pairing mode in which the pairing module 134 is calibrated and paired with particular electronic devices 102. The monitoring device 100 may include one or more buttons that may change the operating mode of the monitoring device 100, such as to enter the pairing mode. Once the electronic devices 102 have been paired with the monitoring device 100, the monitoring device 100 will interrogate the compartment of the vehicle 130 to search for such electronic devices 102. The monitoring devices 100 may indicate the presence and/or absence of all the electronic devices 102 paired with the monitoring device 100.

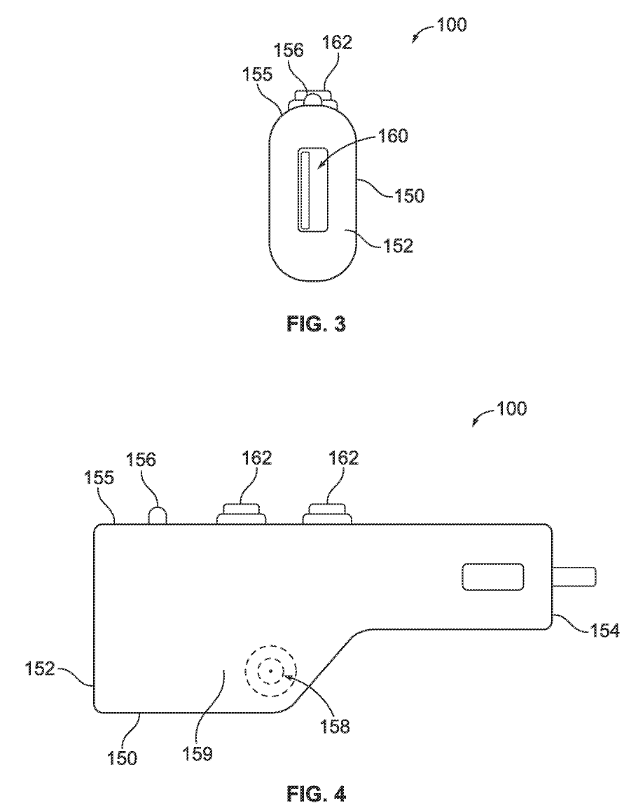

FIG. 3 is a front view of the monitoring device 100. FIG. 4 is a side of the monitoring device 100. The monitoring device 100 includes a body 150 extending between a front end 152 and a rear end 154. The rear end 154 is configured to be plugged into a 12 v power socket or cigarette lighter port for powering the monitoring device 100.

A side 155 of the body 150 includes an indicator 156 that forms part of the indicator module 116 (shown in FIG. 1). In the illustrated embodiment, the indicator 156 constitutes an LED. In an alternative embodiment, other types of indicators may be utilized, such as an array of LEDs, a speaker, a digital display and the like. The indicator 156 provides visual indication to the user of the status of the monitoring device 100. The status of the monitoring device 100 may relate to the presence and/or absence of the electronic devices 102 (shown in FIG. 1). For example, when all electronic devices 102 are present, the monitoring device 100 may be operated in a first mode. In the first mode, the indicator 156 indicates a presence of all paired electronic devices 102 to the user. In the first mode, the indicator 156 may be a solid color, such as a green color. When at least one electronic device 102 is absent, the monitoring device 100 may be operated in a second mode. In the second mode, the indicator 156 provides a status that one or more electronic devices 102 are absent to the user. In the second mode, the indicator 156 may blink a predetermined number of times. Alternatively, the indicator 156 may be a different color, such as a red color indicating that one or more electronic devices 102 are absent. If multiple electronic devices 102 are paired with the monitoring device 100, the indicator 156 may indicate the number of electronic devices 102 that are absent. For example, the indicator 156 may blink a predetermined number of times which corresponds to a number of electronic devices 102 that are absent.

The monitoring device 100 includes an indicator 158 (shown in FIG. 4) along another side 159 of the body 150. The indicator 158 constitutes a speaker for providing an audible indication of the status of the monitoring device 100. For example, the indicator 158 may beep when one or more electronic devices 102 are absent. Optionally, the indicator 158 may have one tone to indicate a status that all electronic devices 102 are present, and may have a different tone to indicate that one or more electronic devices 102 are absent.

A USB port 160 is provided at the front end 152. USB connectors may be plugged into the USB port 160. For example, a charger for a cell phone may be plugged into the USB port 160. Power supplied to the monitoring device 100 may be routed to the USB port 160 and used to power the cell phone for charging the cell phone.

One or more control buttons 162 are provided on the side 155. The control buttons 162 may control the operation of the monitoring device 100. For example, the control buttons 162 may be used to turn the monitoring device 100 on or off. The control buttons 162 may be used to mute the indicator 158. The control buttons 162 may be used to change the mode of the monitoring device 100, such as between the pairing mode and the normal mode of operation. The control buttons 162 may be used to switch the monitoring device 100 between different users, such as driver 1 and driver 2, such that the monitoring device 100 may be configured to look for different electronic devices 102 depending on the mode.

The monitoring device 100 may have other shapes, sizes and/or features in alternative embodiments, depending on a particular application. In an alternative embodiment, rather than the monitoring device 100 being removable from the vehicle 130, the monitoring device 100 may be integrated into the vehicle 130, such as into the dashboard of the vehicle 130 or into another subsystem of the vehicle 130, such as the radio or navigation system of the vehicle 130. Information regarding the status of the monitoring device 100 may be displayed on the radio or navigation system, such as a digital display.

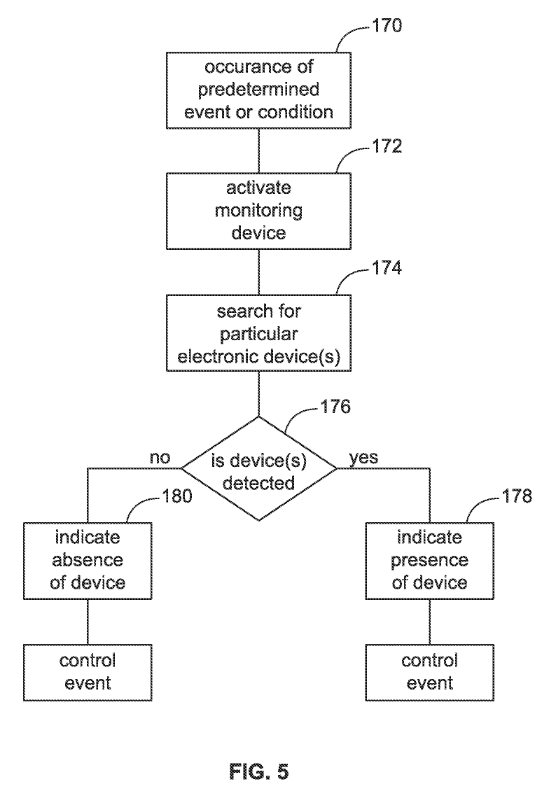

FIG. 5 is a flow chart of an operation of the monitoring device 100. When a predetermined event and/or condition occurs 170, the monitoring device 100 is activated or turned on 172. For example, the predetermined event or condition may be placement of the key in the ignition, starting the car, unlocking the doors, a user sitting in the seat, activation of a sensor used to detect a users presence, turning on the monitoring device 100, and the like. Once turned on, the monitoring device 100 is operated to search 174 for particular electronic devices 102, which have been paired with the monitoring device 100. The monitoring device 100 determines 176 if the electronic devices 102 are present and/or absent.

At decision box 176, if the monitoring device 100 detects a presence of an electronic device 102, the monitoring device 100 indicates 178 the presence of such electronic device 102. Such indication may be visual, audible, or another type of indication. After the presence has been indicated, the monitoring device 100 may be controlled in a particular manner. For example, the monitoring device 100 may be turned off, or the monitoring device 100 may enter a sleep mode for a predetermined period of time or until a predetermined event and/or condition occurs.

At decision box 176, if the monitoring device 100 detects an absence of the electronic device 102, the monitoring device 100 indicates 180 the absence of such electronic device 102. The indication may be visual, audible, or another type of indication. After the absence is indicated, the monitoring device 100 may be controlled in a predetermined way. For example, the monitoring device 100 may be turned off, or the monitoring device 100 may enter a sleep mode for a predetermined amount of time or until a predetermined event and/or condition occurs.

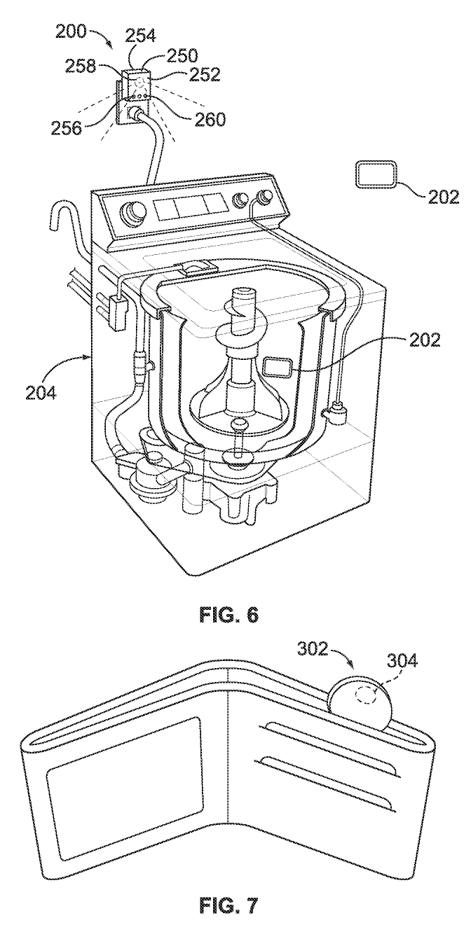

FIG. 6 illustrates an alternative monitoring device 200 for use in detecting the presence and/or absence of an electronic device 202 in the vicinity of an appliance, such as a washing machine 204. The monitoring device 200 is configured to be plugged into a power outlet proximate to the washing machine 204. The monitoring device 200 may be continuously operated and may continuously be searching for electronic devices 202 in the vicinity of the appliance. Alternatively, the monitoring device 200 may be operated upon occurrence of an event or condition, such as opening of the washing machine lid, activation of the washing machine panel, water flow to the washing machine, periodic activation, activation by a sensor, such as a motion sensor, integrated into the monitoring device or connected to the monitoring device, manual activation of the monitoring device, and the like.

The monitoring device 200 communicates wirelessly with the electronic device 202, such as using Bluetooth technology. Optionally, one or more electronic devices 202 may be synced or paired with the monitoring device 200. The monitoring device 200 will interrogate the interrogation space only for such synced devices. Alternatively, the monitoring device 200 may interrogate the interrogation space for any electronic device 202, not just electronic devices 202 synced with the monitoring device 200. When the electronic device 202 is in the interrogation space surrounding the monitoring device 200, the monitoring device 200 indicates to the user the presence of such electronic device 202, such as with a red light or a blinking light and/or an audible alarm. Once the end user has determined all electronic devices 202 are free of danger, the user can clear the alarm and continue with the washer sequence. Optionally, when no electronic devices 202 are in the interrogation space surrounding the monitoring device 200, the monitoring device 200 may indicate to the user the absence of such electronic device 202, such as with a green light on the monitoring device 200. The indication may be visual, audible or another type of indication, such as by controlling operation of the washing machine.

The monitoring device 200 includes a body 250 having a front end 252 and a rear end 254. The rear end 254 is plugged into the power outlet. An indicator 256 is provided at the front end 252. In the illustrated embodiment, the indicator 256 constitutes an LED that indicates the status of the monitoring device 200. For example, the indicator 256 may indicate a presence of the electronic device 202. Alternatively, the indicator 256 may indicate an absence of the electronic device 202. In an exemplary embodiment, the monitoring device 200 includes an indicator 258 at the front end 252. The indicator 258 constitutes a speaker and provides an audible indication of the presence and/or absence of the electronic device 202.

One or more control buttons 260 are provided on the monitoring device 200. The control buttons 260 may control the operation of the monitoring device 200. For example, the control buttons 260 may be used to turn the monitoring device 200 on or off. The control buttons 260 may be used to mute the indicator 258. The control buttons 260 may be used to change the mode of the monitoring device 200, such as between the pairing mode and the normal mode of operation.

In an exemplary embodiment, the monitoring device 200 may be operatively coupled to the washing machine 204. The monitoring device 200 may be able to control an operation of the washing machine 204. For example, the monitoring device 200 may be configured to prevent or shut off a fill operation of the washing machine 204 when the electronic device 202 is detected. Optionally, the monitoring device 200 may communicate with the washing machine 204 via a communication line (not shown) between the monitoring device 200 and washing machine 204. Alternatively, the monitoring device 200 may communicate with the washing machine 204 wirelessly. For example, the same communication module that detects the presence and/or absence of the electronic device 202 may be used to communicate wirelessly with the washing machine 204. In an alternative embodiment, rather than having the monitoring device 200 separate from the washing machine 204, the monitoring device 200 may be integrated into the washing machine 204.

In another exemplary embodiment, the power supply to the washing machine 204 may be routed through the monitoring device 200. For example, the power cord of the washing machine 204 may be plugged into the monitoring device 200, which is plugged into the power outlet. When the monitoring device 200 detects the presence of the electronic device 202, the monitoring device 200 may shut off the power supply to the washing machine 204.

FIG. 7 illustrates an alternative electronic device 302 that may be monitored by a monitoring device, such as the monitoring devices 100, 200. The electronic device 302 constitutes a token that may be placed in a personal item, such as a wallet, a purse, an article of clothing and the like to ensure that such personal item is capable of being monitored by the monitoring device. For example, when the monitoring device is used within the vehicle 130, the electronic device 302 may be placed in the users wallet, purse, jacket and the like to ensure such item is returned to the vehicle 130 with the user.

The electronic device 302 is illustrated as being a circular object, however the electronic device 302 may have other shapes in alternative embodiments, such as a card shape that is sized and shaped similar to a credit card. The electronic device 302 may include a wireless communication component 304, such as a Bluetooth component, therein that is configured to communicate with the monitoring device. Optionally, the electronic device 302 may be plugged into the monitoring device to charge the electronic device 302 when the electronic device 302 is not being used, such as using a USB port or another type of charging port.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second.” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

What is claimed is:

1. A monitoring device for use in a vehicle, the monitoring device comprising:
a body configured to be mounted within the vehicle;
a controller housed within the body, the controller having a communication module configured to detect the presence and/or absence of at least one electronic device in the vicinity of the monitoring device by attempting wireless communication with at least one electronic device; and
an indicator held by the body and operatively connected to the controller for controlling the operation of the indicator;
wherein the controller is operated in a first mode when the communication module detects the presence of the at least one electronic device, and wherein the controller is operated in a second mode when the communication module does not detect the presence of the at least one electronic device.

2. The monitoring device of claim 1, further comprising a power source powering at least one of the controller, the communication module, and the indicator.

3. The monitoring device of claim 1, further comprising a USB port on the body.

4. The monitoring device of claim 1, wherein the indicator includes at least one of a visual indicator, an audible indicator and a vehicle control indicator.

5. The monitoring device of claim 1, wherein the monitoring device is integrated into the vehicle.

6. The monitoring device of claim 1, further comprising a front panel coupled to the body, the front panel includes the indicator, the indicator comprising an LED displaying the status of the presence or absence of the electronic device.

7. The monitoring device of claim 1, wherein the indicator comprises an internal speaker connected to the controller for notification by an audible indication or alarm.

8. The monitoring device of claim 1, further comprising an internal voltage monitor operatively connected to the controller in order to activate the monitoring circuit when the voltage monitor determines that the car ignition has be activated.

9. The monitoring device of claim 1, wherein the electronic device comprises a cell phone.

10. The monitoring device of claim 1, wherein the electronic device has a unique identifier, the communication module searching the vicinity of the vehicle for the electronic device based on the unique identifier.

11. The monitoring device of claim 1, wherein the communication module is previously paired with one or more of the electronic devices, the communication module attempting to search for each electronic device to which the communication module had been previously paired.

12. A monitoring device for use in a vehicle, the monitoring device comprising:
a wireless communication component contained within the vehicle, the wireless communication component being configured to pair with a first cell phone in the compartment of the vehicle; wherein, upon a predetermined event, the wireless communication component is operated to verify the presence and/or absence of the first cell phone.

13. The monitoring device of claim 12, wherein the predetermined event comprises starting of the vehicle, the wireless communication component being configured to receive a signal upon starting of the vehicle, the wireless communication component.

14. The monitoring device of claim 12, further comprising an indicator operatively coupled to the wireless communication component, the indicator being operable in a first mode when the communication module detects the presence of the first cell phone, and the indictor being operable in a second mode when the wireless communication component does not detect the presence of the first cell phone.

15. The monitoring device of claim 12, wherein the wireless communication component is configured to pair with a second cell phone in the compartment of the vehicle; wherein, upon the predetermined event, the wireless communication component is operated to verify the presence and/or absence of the second cell phone.

16. A monitoring device for use with an appliance, the monitoring device comprising:
a body configured to be mounted adjacent the appliance;
a controller housed within the body, the controller having a communication module configured to detect the presence and/or absence of at least one electronic device in the vicinity of the monitoring device by attempting wireless communication with at least one electronic device; and
an indicator held by the body and operatively connected to the controller for controlling the operation of the indicator;
wherein the controller is operated in a first mode when the communication module detects the presence of the at least one electronic device, and wherein the controller is operated in a second mode when the communication module does not detect the presence of the at least one electronic device.

17. The monitoring device of claim 16, wherein the indicator includes at least one of a visual indicator, an audible indicator and an appliance control indicator.

18. The monitoring device of claim 16, wherein the monitoring device is integrated into the appliance.

19. The monitoring device of claim 16, wherein the communication module is previously paired with one or more of the electronic devices, the communication module attempting to search for each electronic device to which the communication module had been previously paired.

20. The monitoring device of claim 16, wherein a power supply to the appliance is controlled by the monitoring device, wherein the monitoring device shuts off power supply to the appliance when the communication module detects the presence of the at least one electronic device.
